(19) United States
(12) Patent Application Publication
(10) Pub. No.: US 2006/0124536 A1
(43) Pub. Date: Jun. 15, 2006

(54) Filter with a multiplicity of shims to create an internal press fit around the area of the mixing blade to be used with a multiplicity of different blenders

(75) Inventor: Juan Ceron Guerrero, Distrito Federal (MX)

Correspondence Address: ROZSA LAW GROUP LC, 15910 VENTURA BOULEVARD, SUITE 1601, ENCINO, CA, 91436-2815, US

(73) Assignee: Millennium Valet Parking Corporation dba TV Mas USA

(21) Appl. No.: 11/165,673

(22) Filed: Jun. 23, 2005

(30) Foreign Application Priority Data
Dec. 10, 2004 (MX) PA/A/2004/012449

(51) Int. Cl. B01D 35/28

(52) U.S. Cl. 210/473; 210/435; 366/205

(57) ABSTRACT

A filter or juicer which is designed to accommodate a multiplicity of different shims at its base in order to enable the filter to be used with a multiplicity of different blenders having a food container having internal chambers of varying diameters at its lower section and blade assemblies of varying diameters. The filter with a multiplicity of shims is used to create an internal press fit to be used within a multiplicity of different blenders to enable juices to be extracted from fruit and vegetables placed within the filter after the filter has been placed in the chamber of the blender.

### BACKGROUND OF THE INVENTION

1. Field of the Invention

The present invention relates to the field of filters which are inserted into a blender in order to facilitate the process of juicing where the juice is extracted from fruits and vegetables and is separated from the pulp which is retained within the filter.

2. Description of the Prior Art

In general, the concept of filters to be used in conjunction with a blender to separate the juice from the pulp of fruits and vegetables is known in the prior art. The following nine (9) patents are relevant to the present invention:

1. U.S. Pat. No. 33,973 issued to Goewey on Dec. 17, 1861 for “Churn” (hereafter the “Goewey Patent”);

2. U.S. Pat. No. 375,024 issued to Pursley on Oct. 29, 1996 for “Juicing Adapter For Blenders” (hereafter the “Pursley Patent”);

3. U.S. Pat. No. 5,662,032 issued to Baratta on Sep. 2, 1997 for “Juicer Attachment For A Blender” (hereafter the “Baratta Patent”);

4. U.S. Pat. No. 5,690,021 issued to Grey on Nov. 25, 1997 for “Strainer Insert For blender” (hereafter the “Grey Patent”);

5. U.S. Pat. No. 6,065,861 issued to Chen on May 23, 2000 for “Blender And Assembling Such A Blender” (hereafter the “'861 Chen Patent”);

6. U.S. Pat. No. 6,135,019 issued to Chou on Oct. 24, 2000 for “Filter Assembly For A Blender” (hereafter the “Chou Patent”);

7. U.S. Pat. No. 6,223,652 B1 issued to Calia on May 1, 2001 for “Kitchen Appliance Comprising A Container With A Filter” (hereafter the “Calia Patent”);

8. U.S. Pat. No. 6,499,873 B1 issued to Chen on Dec. 31, 2002 for “Fruit/Vegetable Blender” (hereafter the “'873 Chen Patent”);

9. U.S. Pat. No. 6,817,750 B1 issued to Sands on Nov. 16, 2004 for “Individualized Blender” (hereafter the “Sands Patent”).

The Goewey Patent discloses the concept of a central filter in an old mechanical blender which is used to churn milk into butter.

The Pursley Patent is a design patent and discloses a filter cartridge with top and bottom end pieces.

The Baratta Patent discloses a juicer attachment for a blender wherein the juicer attachment extends well above the vertical height of the blender. The invention also incorporates the use of a plunger which is used to dislodge food material from the blade of the blender. It also incorporates a base at the lower end of the juicer.

The Grey Patent discloses the concept of a strainer fitted into the interior chamber of a blender. The relevant portion of the patent disclosure states:

“Referring to FIGS. 1 and 2, a strainer chamber (1) of cylindrical shape has strainer openings (2) about a portion of its circumference. The strainer chamber (1) has a lid recess (3) for purpose of attaching a lid (4). The lid recess (3) and lid (4) may be engaged by a friction fit, by means of cooperatively located threaded elements, or other suitable methods for closing. On the strainer chamber (1) bottom end there is a mounting base attachment (5). A mounting base (6) is permanently attached to the blender base (7) by placing the mounting base (6) over the blender base (7) and placing the blender base sealing ring (8) and attachment ring (9) over a mounting base flange (12) to secure both the mounting base (6) and blender mixing chamber (not shown) to the blender base (7).

With this configuration, when the strainer chamber (1) is attached to the mounting base (6) the strainer chamber (1) is contained in the blender mixing chamber (not shown) and encloses the blender blades (10). The mounting base attachment (5) and mounting base (6) are illustrated with threads (11) for purpose of attachment.”

A key feature of this invention is having the base of the strainer affixed onto the base of the blender.

The '861 Chen Patent discloses the concept of having the strainer within the blender. What apparently appears to be patentable about this device is that in addition to straining the solid pulp from the fruit or juice, the strained liquid is then poured into a second blender where it is heated into a soup. Once again, this device shows the concept of having the bottom of the strainer affixed to the blender base.

The Chou Patent is a filter assembly for a blender which contains an internal filter cartridge into which the various solid fruits are placed. Referring to Column 4 beginning on Line 12, the patent states “The filter member 30 has a hollow perforated cylinder with an annular upper end 32 and a lower end 34. The perforations 78 in the filter member 30 are sized such that juice of the fruits or vegetables which are being processed, pass through the perforations of the perforated cylinder 30 into the juice compartment 70 but pulps and pips remain within the pulp compartment 72 of the perforated cylinder 30. When in use, the filter member 30 is aligned with the central feeder opening 42 and press fits underneath the main cap member 40.”

The Calia Patent also discloses a filter assembly for use within the interior chamber of a blender. The filter is held in a fixed position in the container of the blender during operation in that the filter is locked in between the bottom and the lid of the container.

The '873 Chen Patent is by the same inventor as the inventor of the dual device for heating soup after the liquid has been filtered out of the pulp. In this case, the invention includes a filter member 22 which is engaged with the inner bottom of the container 20 and the blade device 21 is located in the filter member 22. The inner bottom of the container 20 has three notches 201 and the filter member 22 has three bosses 224 which are engaged with the notches 201. The filter member 22 includes a porous section 222 and a non-porous section 221, the blade device 21 enclosed by the porous section 222 so that the juice will flow from the porous section 222 and retain the space between the filter member 22 and the container 20, while larger particles are retained in the porous section 222. Two lugs 225 extend from the non-porous section 221 for facilitating assembly of the filter member 22. In this case, the filter is located only at the lower bottom portion of the container.

Finally, the Sands Patent is also for a blender insert which has a filter. Specifically referring to Column 3, the patent reads “According to one exemplary embodiment, the blender container 106 may include a juicer member 111. The juicer element 111 is composed of a main body 113 and a plurality of sieve elements 114 spaced about the periphery of the main body 113. According to the exemplary embodiment depicted in FIG. 1, the juicer element 111 may also include a funnel 112 at one end of the main body 113. Additionally, the juicer element 111 may also include an annular stop member 115 positioned at one end of the juicer so as to prevent over insertion of the juicer element 111 into the blender container 106.”

While the concept of having a filter which may be press fit within the interior chamber of a blender is disclosed in a number of the patents discussed above, this is accomplished by having a filter cartridge that is specifically designed for a specific blender. There is a significant need for an improved filter cartridge that can fit a multiplicity of blenders having

### SUMMARY OF THE INVENTION

The present invention is a filter or juicer which is designed to accommodate a multiplicity of different shims at its base in order to enable the filter to be used with a multiplicity of different blenders having different sizes and diameters of mixing blades which extend into a food container having internal diameters in the area of the mixing blade. The filter with a multiplicity of shims is used to create an internal press fit in the area of the mixing blade to be used within a multiplicity of different blenders to enable juices to be extracted from fruit and vegetables placed within the filter after the filter has been placed in the chamber of the blender.

The present invention is a filter that is used with a blender to be able to extract juices from various fruits and vegetables that are inserted into the filter and then having the blender turned on.

It has been discovered, according to the present invention, that if the filter cartridge is designed to accept a multiplicity of different base shims on its lower end which multiplicity of base shims have varying heights and varying lower diameters, then the specific shim can be selected so that its lower diameter accepts a blender blade of a given diameter and height.

It is therefore an object of the present invention to provide a filter for a blender which is designed to accommodate a multiplicity of different base shims of a given height and lower diameter so that the combined filter and lower base shim can be designed to accommodate any type of blender having different blade diameters and heights.

It is another object of the present invention to provide a complete filter kit which includes a filter cartridge, a top for the filter cartridge, and a series of different base shims to be received in the lower end of the filter cartridge so that a user can select the appropriate shim to accommodate any specific blender having an interior chamber of a given height and having a mixing blade of any given diameter.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a side elevational view of one embodiment of the present invention illustrating a filter cartridge with a top cover and a selected bottom shim;

FIG. 2 is a perspective view of a filter cartridge of the present invention when viewed from the bottom;

FIG. 3 is a perspective view of a filter cartridge of the present invention when viewed from the top;

FIG. 4 is a perspective view of the present invention filter cartridge placed into the jar of a blender with the jar placed on the base of the blender where the combination shim, filter cartridge and top fit within the jar of the blender;

FIG. 5 is a perspective view of the present invention filter cartridge placed into the jar of a blender with the jar placed on the base of the blender where the combination shim, filter cartridge and top are of a sufficient height that a portion of the cartridge and the top extend above the jar of the blender;

FIG. 6 is a top plan view looking down into the jar of a blender from lines 6-6 of FIGS. 4 and 5 showing a shim fitting within the base of the jar and around the mixing blade, when the present invention filter assembly placed inside of the jar of the blender;

FIG. 7a is a side elevational view of the top of the present invention filter assembly;

FIG. 7b is top plan view of the top of the present invention filter assembly;

FIG. 8 is a side elevational view of shim attachment “A” of the present invention;

FIG. 9 is a top plan view of shim attachment “A” of the present invention;

FIG. 10 is a bottom plan view of shim attachment “A” of the present invention;

FIG. 11 is an exploded view of shim attachment “A” and filter cartridge with shim attachment “A” removed;

FIG. 12 is a side elevational view with shim attachment “A” attached to the filter cartridge;

FIG. 13 is a side elevational view of shim attachment “B” of the present invention;

FIG. 14 is a top plan view of shim attachment “B” of the present invention;

FIG. 15 is a bottom plan view of shim attachment “B” of the present invention;

FIG. 16 is an exploded view of shim attachment “B” and filter cartridge with shim attachment “B” removed;

FIG. 17 is a side elevational view with shim attachment “B” attached to the filter cartridge;

FIG. 18 is a side elevational view of shim attachment “3” of the present invention;

FIG. 19 is a top plan view of shim attachment “3” os the present invention;

FIG. 20 is a bottom plan view of shim attachment “3” of the present invention;

FIG. 21 is an exploded view of shim attachment “3” and filter cartridge with shim attachment “A” removed;

FIG. 22 is a side elevational view with shim attachment “3” attached to the filter cartridge;

FIG. 23 is a side elevational view of shim attachment “1” of the present invention;

FIG. 24 is a top plan view of shim attachment “1” of the present invention;

FIG. 25 is a bottom plan view of shim attachment “1” of the present invention;

FIG. 26 is a side elevational view showing shim attachment “1” inserted into shim attachment “A”.

FIG. 27 is an exploded view of shim attachments “1” and “A” and filter cartridge with shim attachments “1” and “A” removed.

FIG. 28 is a side elevational view with the combination shim attachments “1” and “A” attached to the filter cartridge.

FIG. 29 is a side elevational view of shim attachment “2” of the present invention;

FIG. 30 is a top plan view of shim attachment “2” of the present invention;

FIG. 31 is a bottom plan view of shim attachment “2” of the present invention;

FIG. 32 is a side elevational view showing shim attachment “2” inserted into shim attachment “B”;

FIG. 33 is an exploded view of shim attachments “2” and “B” and filter cartridge with shim attachments “2” and “B” removed; and

FIG. 34 is a side elevational view with the combination shim attached “2” and “B” attached to the filter cartridge.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

The present invention is a filter assembly with variable base shims to enable the filter assembly to be housed with a multiplicity of different blenders having a jar or food container of varying lower diameters and having a mixing blade of varying diameters and heights. The filter assembly is used with a blender to be able to extract juices from various fruits and vegetables that are inserted into the filter and then having the blender turned on.

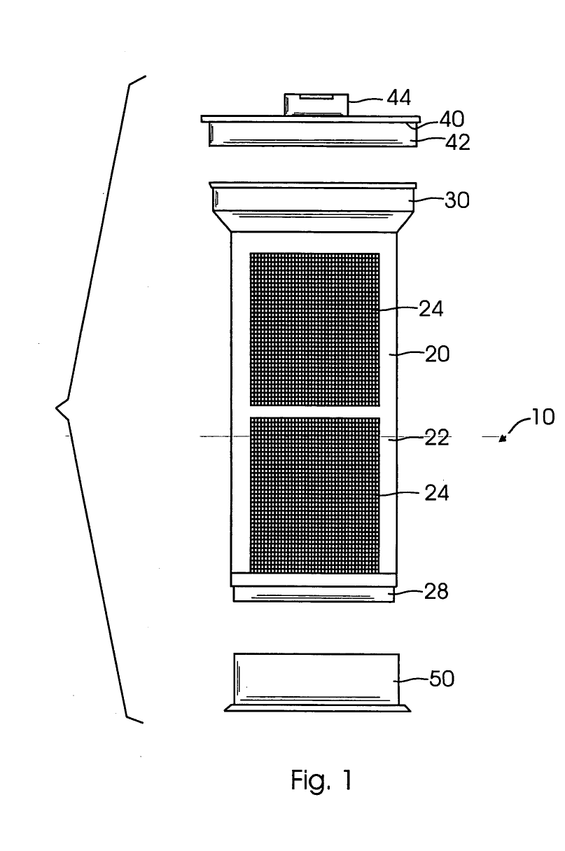

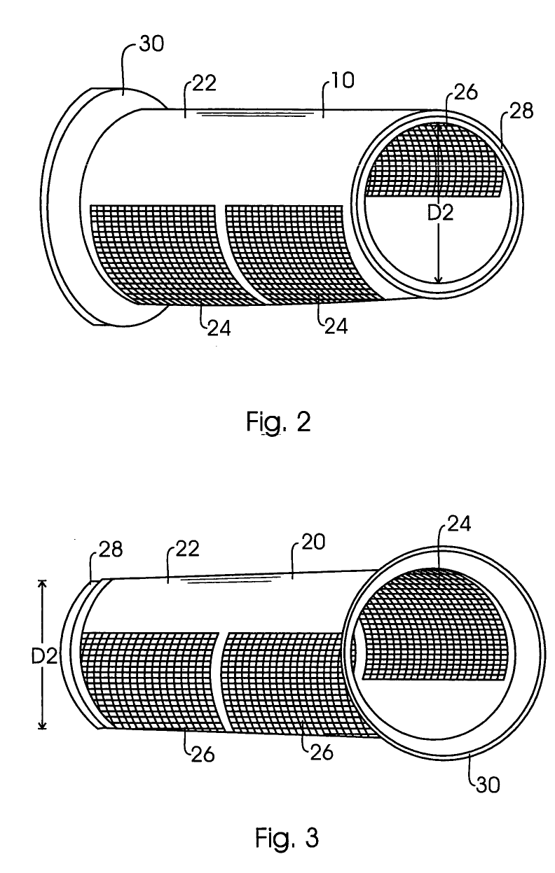

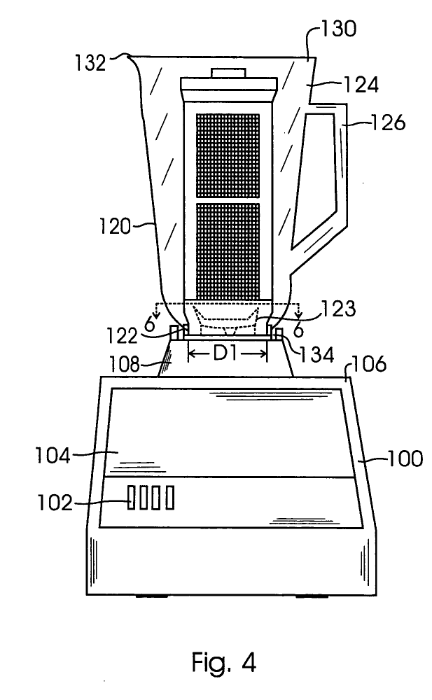

Referring to FIGS. 1 through 3, there is illustrated the present invention filter assembly 10 which is comprised of a main filter cartridge 20, a top 30 and a bottom shim. The main filter cartridge 20 has a circumferential sidewall 22 which has a multiplicity of openings 24 and 26 and opposite sides of the sidewall 22, as best illustrated in FIGS. 3 and 4. The opposite openings 24 and 26 are 180 degrees apart on opposite sides of the main filter cartridge 20.

Each of the multiplicity of openings 24 and 26 are diamond shaped so that they are larger on the outside of the sidewall 22 and smaller on the interior of sidewall 22. The bottom 28 of main filter cartridge 20 has a given diameter D2.

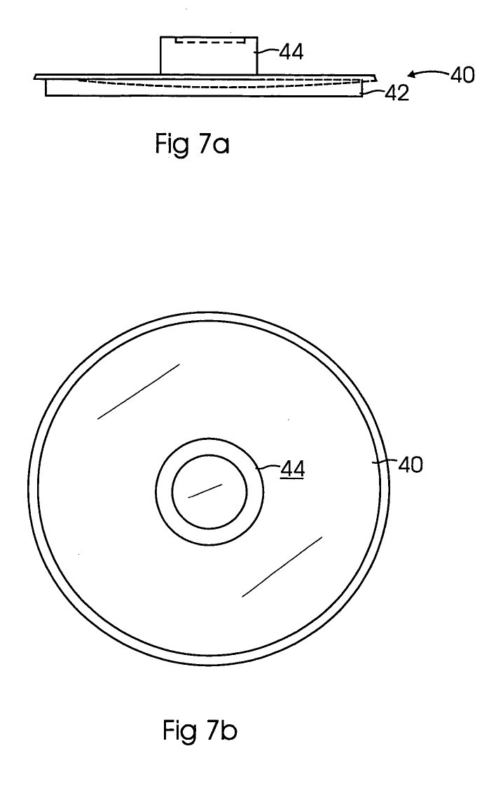

The top 30 of main filter cartridge 20 is of a given shape and diameter so as to receive filter top or cap 40. Referring to FIGS. 1 and 7, the top 40 has a lower section 42 to be received within the top 30 of main filter cartridge 20 and a handle 44 by which the top 40 is gripped.

Referring to FIG. 4, one type of conventional blender includes a base 100 having an interior motor which drives a mixing blade (shown in dashed liens as 123) at the top of the base 100 which mixing blade 123 extends into the food container or jar 120. The base 100 has control buttons 102 located on a portion of the base 100 such as sidewall 104 and has a top surface 106 supporting a food container receiving a support section 108. The food container 120 has a lower section 122 which is received within (or received on depending on the design) the support section 108.

The food container 120 is ajar having a sidewall 124 supporting a handle 126. The food container 120 has an interior chamber 130 into which food is placed and a top (not shown) which is received within the top 132 to close the food container. The interior chamber 130 has a given height. The food container has a lower section 134 having a given interior diameter D1. In this embodiment, the height of the combination shim, filter cartidge 10 and cap 40 fit within the jar.

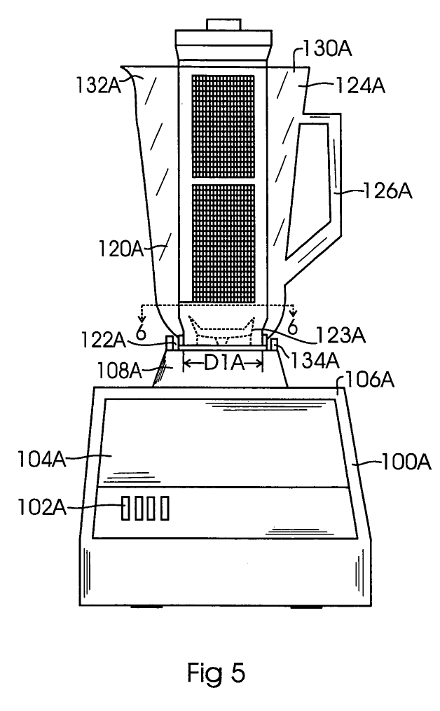

An alternative embodiment of a blender is illustrated in FIG. 5. This alternative embodiment includes a base 100A having an interior motor which drives a mixing blade (shown in dashed liens as 123A) at the top of the base 100A which mixing blade 123A extends into the food container or jar 120A. The base 100A has control buttons 102A located on a portion of the base 100A such as sidewall 104A and has a top surface 106A supporting a food container receiving a support section 108A. The food container 120A has a lower section 122A which is received within (or received on depending on the design) the support section 108A.

The food container 120A is ajar having a sidewall 124A supporting a handle 126A. The food container 120A has an interior chamber 130A into which food is placed. The food container 120A has a top 132A. The interior chamber 130 has a given height. The food container has a lower section 134A having a given interior diameter D1A which is different from the diameter D1 of the food container 120 illustrated in FIG. 4. In this embodiment, the height of the combination shim, filter cartridge 20 and cap 40 extend above the top 132 of the jar 120.

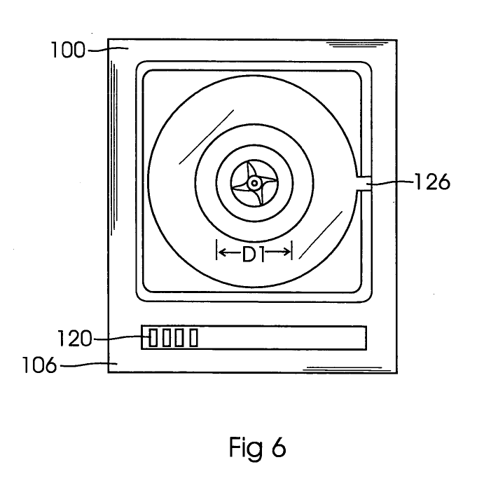

The key to the present invention is illustrated in FIG. 6. Different blenders will have different size interior diameters such as D1 and D1A at the base of food container 120 and 120A respectively and will have different size, height and diameter mixing blades 123 and 123A. The reason for a multiplicity of shims is to accommodate different sizes of mixing blades such as 123 and 123A within different lower diameters such as D1 and D1A of the jar such as 120 or 120A.

As illustrated in FIG. 4, the main filter cartridge 20 is placed within the interior chamber 130 of food container or jar 120. Various fruits and vegetables are placed within the interior chamber of main filter cartridge 20. The fruits and vegetables can either be cut up or placed into the main filter cartridge 20 without being cut up. Optionally, water can be placed into the location of the interior chamber 130 outside the location of the main filter cartridge 20.

The same is true of the alternative embodiment illustrated in FIG. 5 except a portion of the filter cartridge 20 and its top 40 extend out of the top 132A of the jar 120A.

The key concept of the present invention is as follows. There are different blenders on the market which have different size mixing blades 123 and different lower interior diameters on the base of the jar. In order to have the filter assembly work properly, it is necessary that the filter assembly 10 be firmly stabilized within the interior chamber 130 and jar 120. This is necessary in order to maintain a proper mixing so that the juice of the fruits and vegetables are separated from the pulp so that the juice flows through the openings 24 and 26 in the main filter cartridge 20 while the pulp remains within the interior of the main filter cartridge. The separated juice can thereafter be poured out of the food container 120.

There are numerous different types of blenders and mixers which are on the market and for each separate blender, the food container 120 has its own given height and its own interior lower diameter D1 which is slightly larger than the diameter of the mixing blade 123 which is located immediately above support section 108 of the blender. The key feature of the present invention is to create a multiplicity of lower shims which are press fit onto the bottom 28 of main filter cartridge 20 and press fit at the lower section 122 of food container 120 so that its diameter is wider than the diameter of the mixing blade and just fits within lower section 122 adjacent interior wall 124 at lower section 122 so that the total height and diameter of the shim form a press fit within the lower area of the food container 120 to stabilize the filter cartridge 20 within the food container 120. Since different blenders have different lower interior food container diameters and different mixing blades, the present invention facilitates having the correct lower shim to form a stable press fit within the lower section 122 of the food container 120 so that the filter is very stable during the mixing process after the blender is turned on and the mixing blade serves to separate the juice from the pulp of the fruits and vegetables.

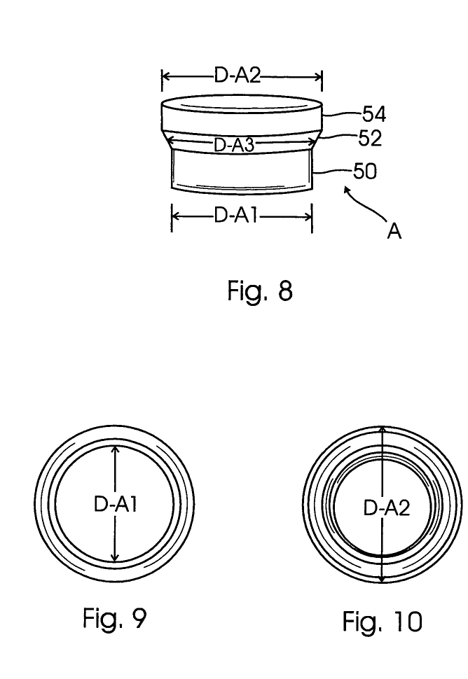

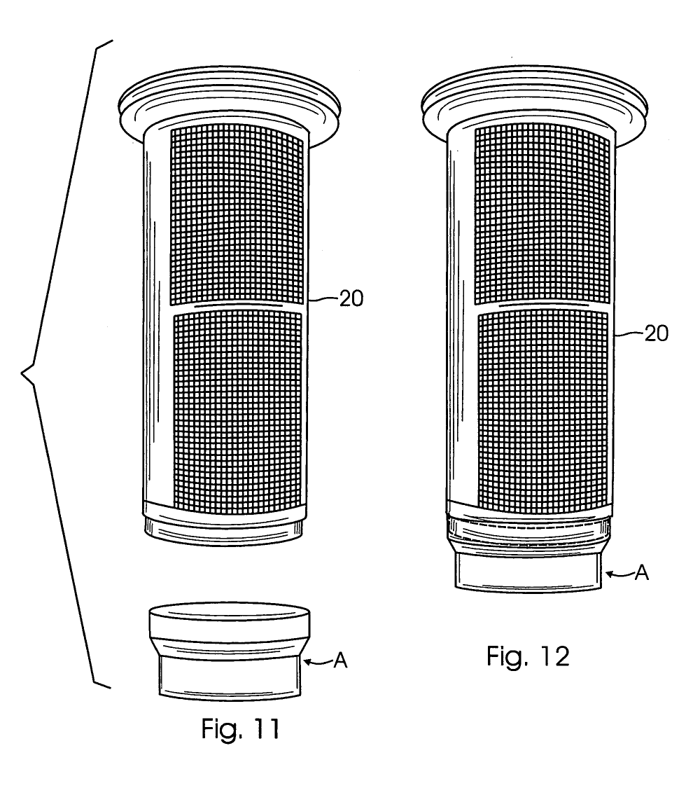

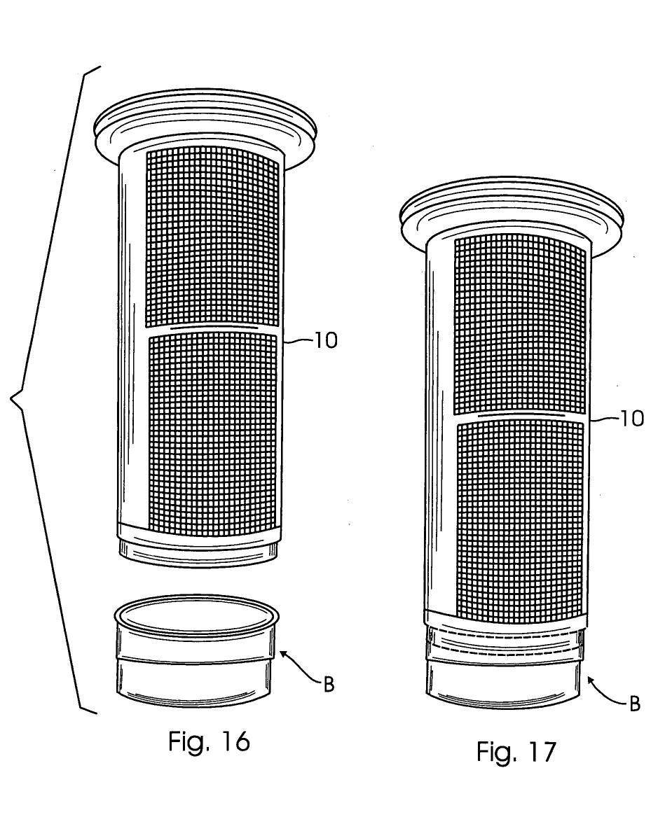

Examples of different embodiments of shims are illustrated in FIGS. 8 through 33. The first embodiment of a shim “A” is illustrated in FIG. 1 and in FIGS. 8 through 12. The shim “A” has three different sections 50, 52 and 54 wherein bottom section 50 has a diameter D-A1 is slightly smaller than the diameter D1 of the interior of the lower section of food container 120 and a middle section 52 which has a diameter D-A3 which is slightly larger than the diameter of the mixing blade 123. Upper section 54 has a diameter D-A2 which is slightly larger than the diameter of the bottom of the filter cartridge 20. An exploded view of the assembly is shown in FIG. 11 and the assembled view as it will fit within the food container is illustrated in FIG. 12. The diameter D-A1 is wide enough so that it is just slightly smaller than the diameter D1 of the interior chamber 130 of the lower section 122 of food container 120. The diameter D-A2 is configured relative to diameter D2 of the main filter cartridge 20 so that the shim “A” fits around the main filter cartridge so that there is a press fit therebetween. The shim “A” is designed to accommodate this specific blender.

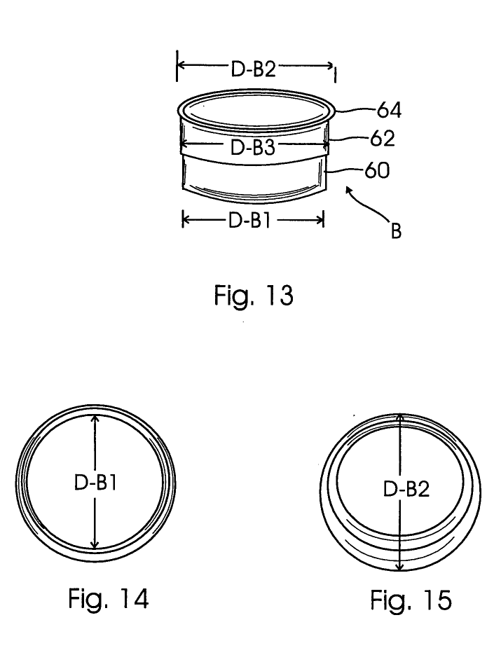

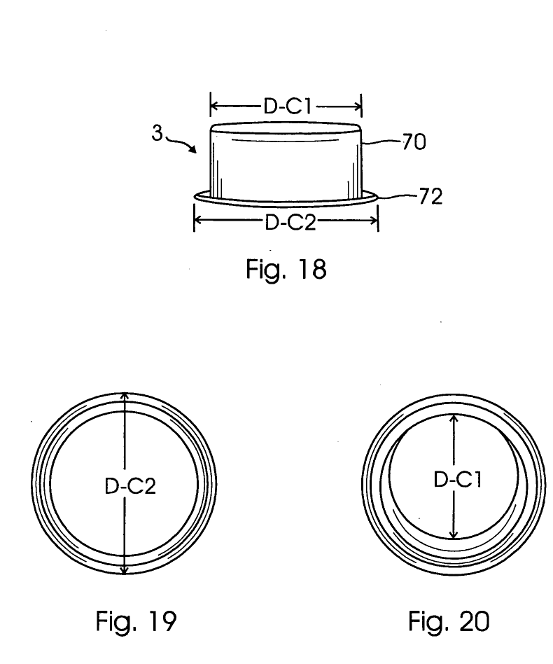

A second embodiment of a shim “B” is illustrated in FIGS. 13 through 17. Shim “B” has two different sections 60 and 62 and a base ring 64 wherein bottom section 60 has a diameter D-B1 which is slightly smaller than the diameter D1A of the interior of the lower section of food container 120A, and a middle section 62 which has a diameter D-B3 which is slightly larger than the diameter of the mixing blade 123. Upper ring section 64 has a diameter D-B2 which is slightly larger than the diameter D2 of the lower portion of filter cartridge 10. An exploded view of the assembly is shown in FIG. 17 and the assembled view as it will fit within the food container is illustrated in FIG. 18. The diameter D-B1 is wide enough so that it is just slightly smaller than the diameter D1A of the interior chamber 130A of the lower section 122A of food container 120A. The diameter D-B2 is configured relative to diameter D2 of the main filter cartridge 20 so that the shim “B” fits around the main filter cartridge so that there is a press fit between them. The shim “B” is designed to accommodate this specific blender.

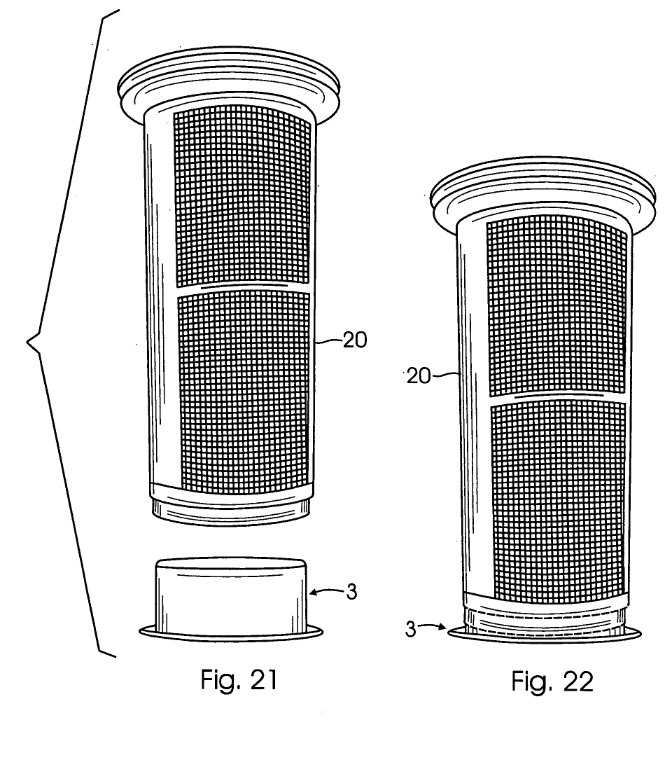

A third embodiment of a shim “3” is illustrated in FIGS. 18 through 22. Shim “3” has one section 70 and a base ring 72 wherein section 70 has a diameter D-C1 which is slightly larger than the diameter of mixing blade 123 and is also slightly smaller than the diameter D2 of the lower portion of the filter cartridge 20 and a ring section 72 which is slightly smaller than the diameter D1A of the interior of the lower section of food container 120A. An exploded view of the assembly is shown in FIG. 21 and the assembled view as it will fit within the food container is illustrated in FIG. 22. The diameter D-C1 is wide enough so that it is greater than the diameter of the mixing blade 123 of the blender. The diameter D-C2 is just slightly smaller than the diameter D1A of the interior chamber 130A of the lower section 122A of food container 120A. The diameter D-C1 is configured relative to diameter D2 of the main filter cartridge 20 so that the shim “3” fits within the main filter cartridge so that there is a press fit between them. The shim “3” is designed to accommodate this specific blender. Although described with the 120A embodiment, it will be appreciated that this is a third variety of blender jar with a different interior diameter D1A than previously described.

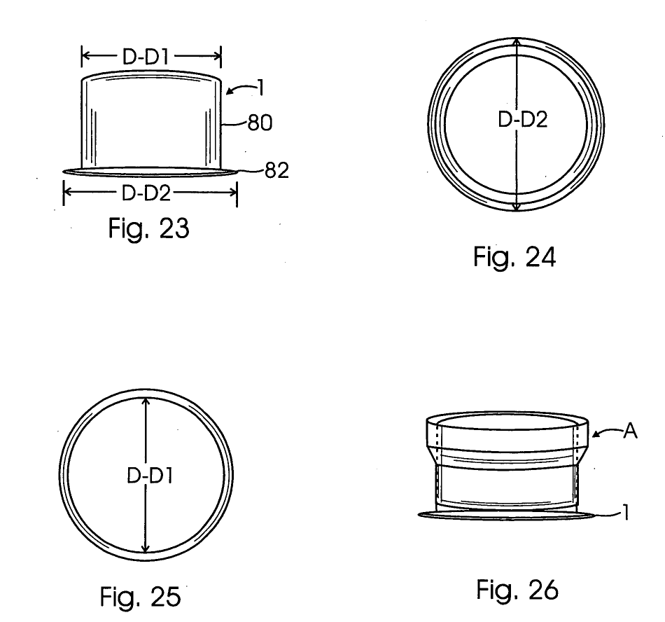

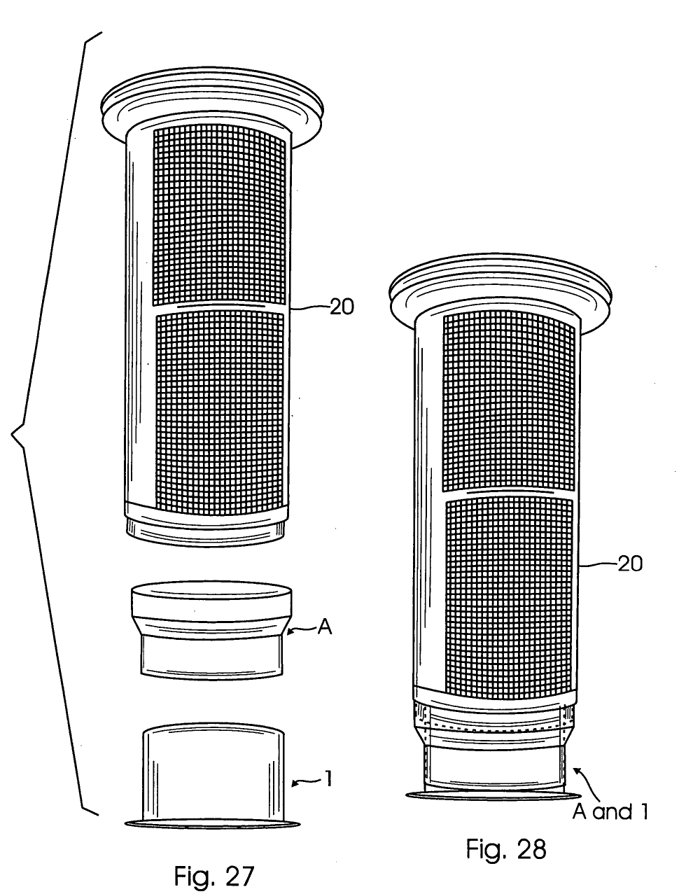

A fourth embodiment of a shim “1” is illustrated in FIGS. 23 through 28. Shim “1” cannot be used by itself and must be used in conjunction with shim “A”. Shim “1” has a body 80 and a ring section 82. The diameter D-D1 of body 80 just fits within diameter D-A1 of section 50 of shim “A” and is also slightly larger than the diameter of the mixing blade. The diameter D-D2 of ring section 82 is just slightly smaller than the diameter D1 of the interior of the lower section of food container 120. The shim “A” has three different sections 50, 52 and 54 wherein bottom section has a diameter D-A1 which is slightly larger than the diameter of mixing blade 123 and also is slightly larger than the diameter D-D1. Upper section 54 has a diameter D-A2 which is slightly larger than the diameter D2 of the lower portion of filter cartridge 10. An exploded view of the assembly is shown in FIG. 27 and the assembled view as it will fit within the food container is illustrated in FIG. 26. The diameter D-D1 is wide enough so that it is greater than the diameter of the mixing blade 123 of the blender. The diameter D-A2 is configured relative to diameter D2 of the main filter cartridge 20 so that the shim “A” fits around the main filter cartridge so that there is a press fit between. The shim combination “1” and “A” is designed to accommodate this specific blender. Although described with the 120 embodiment, it will be appreciated that this is a fourth variety of blender jar with a different interior diameter D1 than previously described.

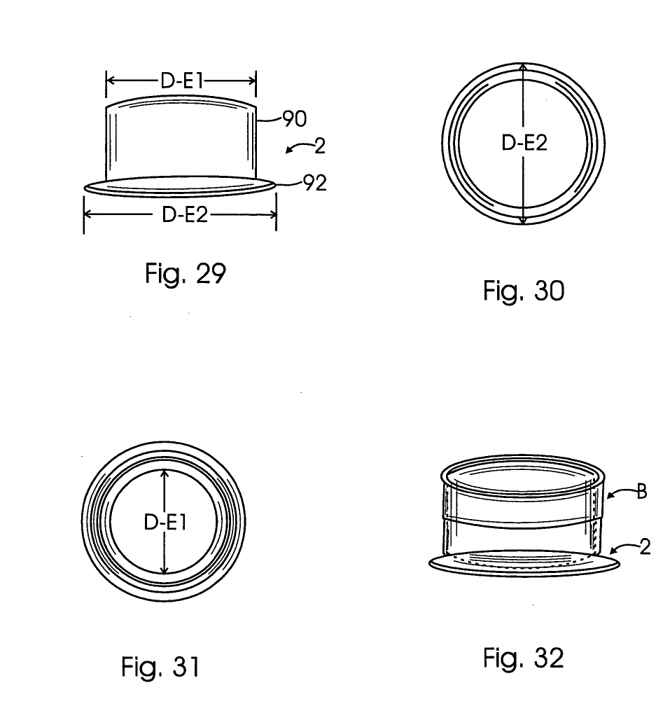

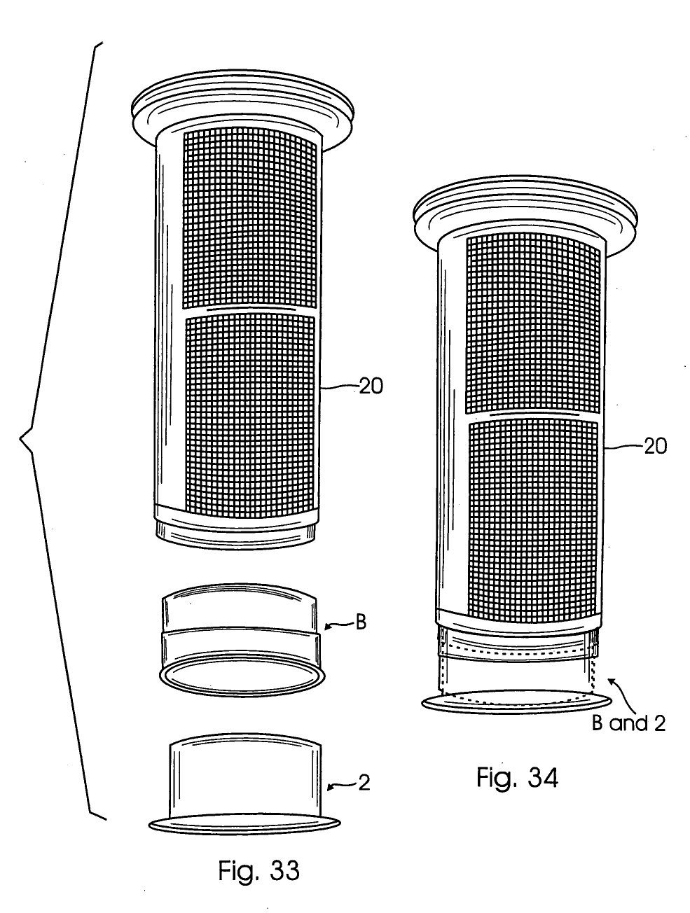

A fifth embodiment of a shim “2” is illustrated in FIGS. 29 through 34. Shim “2” cannot be used by itself and must be used in conjunction with shim “B”. Shim “2” has a body 90 and a ring section 92. The diameter D-E1 of body 80 just fits within diameter D-B1 of section 60 of shim “B” and is also slightly larger than the diameter of the mixing blade. The diameter D-E2 of ring section 92 is just slightly smaller than the diameter D1 of the lower interior 122 of food jar 120. Shim “B” has two different sections 60 and 62 and a base ring 64 wherein bottom section 60 has a diameter D-B1 which is slightly larger than the diameter of D-E1 of section 90. An exploded view of the assembly is shown in FIG. 33 and the assembled view as it will fit within the food container is illustrated in FIG. 34. The diameter D-B1 is wide enough so that it is greater than the diameter of the mixing blade 123 of the blender. The diameter D-B2 is configured relative to diameter D2 of the main filter cartridge 20 so that the shim “B” fits around the main filter cartridge so that there is a press fit between them. The shim combination “2” and “B” is designed to accommodate this specific blender. Although described with the 120 embodiment, it will be appreciated that this is a fifth variety of blender jar with a different interior diameter D1 than previously described.

The present invention will be sold in a kit form with a main filter cartridge 20, a top 30 and a multiplicity of different shims such as “A”, “B”, “1”, “2” and “3” so that the kit can accommodate numerous sizes of blender food containers with different blade sizes and configurations an different interior jar diameters. It will be appreciated that the design of the shims as illustrated in FIGS. 8 through 38 are merely representative examples of numerous other shim designs, all of which are within the spirit and scope of the present invention.

Defined in detail, the present invention is a filter cartridge for use with a blender and to accommodate a multiplicity of different blenders each having a food container which has an interior chamber with a lower section of a given interior diameter and a mixing blade of a given diameter within the interior chamber of the food container and positioned adjacent its lower section, the filter cartridge comprising: (a) a main filter cartridge having a circumferential sidewall having a multiplicity of openings, a top surface which accommodates a mating top, and a bottom portion having a given diameter; (b) a mating lower shim having at least one sidewall having a top of a given interior and exterior diameter so that the top of the shim can be press fit either onto or into the bottom portion of the main filter cartridge, the shim having an interior chamber with an interior diameter which is large enough to accommodate the diameter of the mixing blade, the shim further having a lower base section of a given diameter just slightly smaller than the given interior diameter of the lower section of the interior chamber of the food container; and (c) a multiplicity of different shims to accommodate different sizes of food containers for different blenders so that a given shim can be selected from the multiplicity of shims which selected shim has the required height and required width so as to achieve an interior press fit with the lower section of the food container and to accommodate the given diameter of the mixing blade and also has a press fit with the main filter cartridge to thereby accommodate the mixing blade and lower food container section of the selected blender.

Defined broadly, the present invention is a filter cartridge for use with a blender and to accommodate a multiplicity of different blenders each having a food container which has an interior chamber with a lower section of a given interior diameter and a mixing blade of a given diameter within the interior chamber of the food container and positioned adjacent its lower section, the filter cartridge comprising: (a) a main filter cartridge having a circumferential sidewall having a multiplicity of openings, a top surface which accommodates a mating top, and a bottom portion having a given diameter; (b) a mating lower shim having at least one sidewall having a top of a given interior and exterior diameter so that the top of the shim can be press fit either onto or into the bottom portion of the main filter cartridge, the shim having an interior chamber with an interior diameter which is large enough to accommodate the diameter of the mixing blade, the shim having means so that the shim's outer diameter is slightly smaller than the given interior diameter of the lower section of the interior chamber of the food container; and (c) a multiplicity of different shims to accommodate different sizes of food containers for different blenders so that a given shim can be selected from the multiplicity of shims which selected shim has the required height and required width so as to achieve an interior press fit with the lower section of the food container and to accommodate the given diameter of the mixing blade and also has a press fit with the main filter cartridge to thereby accommodate the mixing blade and lower food container section of the selected blender.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A filter cartridge for use with a blender and to accommodate a multiplicity of different: blenders each having a food container which has an interior chamber with a lower section of a given interior diameter and a mixing blade of a given diameter within the interior chamber of the food container and positioned adjacent its lower section, the filter cartridge comprising:
a. a main filter cartridge having a circumferential sidewall having a multiplicity of openings, a top surface which accommodates a mating top, and a bottom portion having a given diameter;
b. a mating lower shim having at least one sidewall having a top of a given interior and exterior diameter so that the top of the shim can be press fit either onto or into the bottom portion of the main filter cartridge, the shim having an interior chamber with an interior diameter which is large enough to accommodate the diameter of the mixing blade, the shim further having a lower base section of a given diameter just slightly smaller than the given interior diameter of the lower section of the interior chamber of the food container; and
c. a multiplicity of different shims to accommodate different sizes of food containers for different blenders so that a given shim can be selected from the multiplicity of shims which selected shim has the required height and required width so as to achieve an interior press fit with the lower section of the food container and to accommodate the given diameter of the mixing blade and also has a press fit with the main filter cartridge to thereby accommodate the mixing blade and lower food container section of the selected blender.

2. A filter cartridge in accordance with claim 1, wherein said selected shim has a three tiered section, with an upper section having a sidewall of a given diameter to accommodate a bottom of the main filter cartridge, and a lower section with an interior chamber having a diameter sufficient to accommodate the diameter of the mixing blade, and a lower base member of a given diameter which is slightly smaller than the diameter of the interior of the food container at its bottom section.

3. A filter cartridge in accordance with claim 1, wherein said selected shim has a two tiered section with a bottom ring section, with an upper section having a sidewall of a given diameter to accommodate a bottom of the main filter cartridge, the middle section of a given diameter to accommodate the diameter of the mixing blade, and a ring member of a given diameter which is slightly smaller than the diameter of the interior of the food container at its bottom section.

4. A filter cartridge in accordance with claim 1, wherein said selected shim has a body and a ring section, with ring section a given diameter to accommodate a bottom of the main filter cartridge, the body being of a given diameter to accommodate the diameter of the mixing blade and also having a given diameter which is slightly smaller than the diameter of the interior of the food container at its bottom section.

5. A filter cartridge in accordance with claim 1, wherein said selected shim is a combination of two integrated shims which fit within each other so that a portion of the combined shims accommodate a bottom of the main filter cartridge and a portion of the combined shims is of a given diameter which is slightly smaller than the diameter of the interior of the food container at its bottom section.

6. A filter cartridge for use with a blender and to accommodate a multiplicity of different blenders each having a food container which has an interior chamber with a lower section of a given interior diameter and a mixing blade of a given diameter within the interior chamber of the food container and positioned adjacent its lower section, the filter cartridge comprising:
a. a main filter cartridge having a circumferential sidewall having a multiplicity of openings, a top surface which accommodates a mating top, and a bottom portion having a given diameter;
b. a mating lower shim having at least one sidewall having a top of a given interior and exterior diameter so that the top of the shim can be press fit either onto or into the bottom portion of the main filter cartridge, the shim having an interior chamber with an interior diameter which is large enough to accommodate the diameter of the mixing blade, the shim having means so that the shim's outer diameter is slightly smaller than the given interior diameter of the lower section of the interior chamber of the food container; and
c. a multiplicity of different shims to accommodate different sizes of food containers for different blenders so that a given shim can be selected from the multiplicity of shims which selected shim has the required height and required width so as to achieve an interior press fit with the lower section of the food container and to accommodate the given diameter of the mixing blade and also has a press fit with the main filter cartridge to thereby accommodate the mixing blade and lower food container section of the selected blender.

7. A filter cartridge in accordance with claim 6, wherein said selected shim has a three tiered section, with an upper section having a sidewall of a given diameter to accommodate a bottom of the main filter cartridge, and a lower section with an interior chamber having a diameter sufficient to accommodate the diameter of the mixing blade, and a lower base member of a given diameter which is slightly smaller than the diameter of the interior of the food container at its bottom section.

8 A filter cartridge in accordance with claim 6, wherein said selected shim has a two tiered section with a bottom ring section, with an upper section having a sidewall of a given diameter to accommodate a bottom of the main filter cartridge, the middle section of a given diameter to accommodate the diameter of the mixing blade, and a ring member of a given diameter which is slightly smaller than the diameter of the interior of the food container at its bottom section.

9. A filter cartridge in accordance with claim 6, wherein said selected shim has a body and a ring section, with ring section a given diameter to accommodate a bottom of the main filter cartridge, the body being of a given diameter to accommodate the diameter of the mixing blade and also having a given diameter which is slightly smaller than the diameter of the interior of the food container at its bottom section.

10. A filter cartridge in accordance with claim 6, wherein said selected shim is a combination of two integrated shims which fit within each other so that a portion of the combined shims accommodate a bottom of the main filter cartridge and a portion of the combined shims is of a given diameter which is slightly smaller than the diameter of the interior of the food container at its bottom section.
